(19) United States
(12) Patent Application Publication
(10) Pub. No.: US 2011/0120199 A1
(43) Pub. Date: May 26, 2011

(54) MONITORABLE SEALING CABLE LOCK

(75) Inventors: Micha Auerbach, Maccabim (IL); Noach Eizen, Rishon Le Zion (IL); Eli Levy, Nir Ziv (IL)

(73) Assignee: Hi-G Tek, Rockville, MD (US)

(21) Appl. No.: 12/672,992

(22) PCT Filed: Aug. 7, 2008
(86) PCT No.: PCT/IL08/01084

§ 371 Date: Jun. 8, 2010

Related U.S. Application Data
(60) Provisional application No. 60/964,343, filed on Aug. 9, 2007.

(51) Int. Cl. E05B 65/12

(52) U.S. Cl. 70/258

(57) ABSTRACT

A monitorable locking system for a truck cargo compartment closing cable including a cable engagement assembly arranged to selectably retain cable ends in mutually locked engagement, a monitorable locking element assembly and a mechanical lock for locking engagement with the monitorable locking element assembly via the cable engagement assembly, thus locking the cable ends in mutually locked engagement.

### REFERENCE TO RELATED APPLICATIONS

Reference is made to U.S. Provisional Patent Application Ser. No. 60/964,343, filed August 9, 2007 and entitled MONITORABLE SEALING CABLE LOCK, the disclosure of which is hereby incorporated by reference and priority of which is hereby claimed pursuant to 37 CFR 1.78(a) (4) and (5)(i).

### FIELD OF THE INVENTION

The present invention relates to locking systems generally and more particularly to monitorable locking systems.

### BACKGROUND OF THE INVENTION

Various types of monitorable locking systems are known. Preferred locking systems of this type are commercially available from Hi-G-Tek Ltd. of Israel and are described in one or more of their issued U.S. Patents and published pending U.S. and PCT patent applications, the disclosures of which are hereby incorporated by reference.

### SUMMARY OF THE INVENTION

The present invention provides a monitoring locking system particularly useful for trucks having tarpaulins covering all or part of their cargo space and which are tied down and lockable by a cable.

There is thus provided in accordance with a preferred embodiment of the present invention a monitorable locking system for a truck cargo compartment closing cable including a cable engagement assembly arranged to selectably retain cable ends in mutually locked engagement, a monitorable locking element assembly and a mechanical lock for locking engagement with the monitorable locking element assembly via the cable engagement assembly, thus locking the cable ends in mutually locked engagement.

There is also provided in accordance with another preferred embodiment of the present invention a monitorable locking system for a cargo covering closing cable including a cable engagement assembly arranged to selectably retain cable ends in mutually locked engagement; a monitorable locking element assembly and a mechanical lock for locking engagement with the monitorable locking element assembly via the cable engagement assembly, thus locking the cable ends in mutually locked engagement.

Preferably, the monitorable locking element assembly communicates wirelessly with a monitoring center. Additionally or alternatively, the cable includes a monitorable cable communicating wirelessly with a monitoring center.

### BRIEF DESCRIPTION OF THE DRAWINGS

The present invention will be understood and appreciated more fully from the following detailed description, taken in conjunction with the drawings in which:

FIG. 1 is a simplified pictorial illustration of a truck equipped with a monitorable locking system constructed and operative in accordance with a preferred embodiment of the present invention;

FIG. 2 is a simplified exploded view of a locking system constructed and operative in accordance with a preferred embodiment of the present invention;

FIG. 3 is a simplified assembled view of the locking system of FIGS. 1 & 2 mounted on a truck; and

FIGS. 4A & 4B are simplified, partially sectional illustrations of locking operation of the locking system of FIGS. 3 and 4.

### DETAILED DESCRIPTION OF A PREFERRED EMBODIMENT

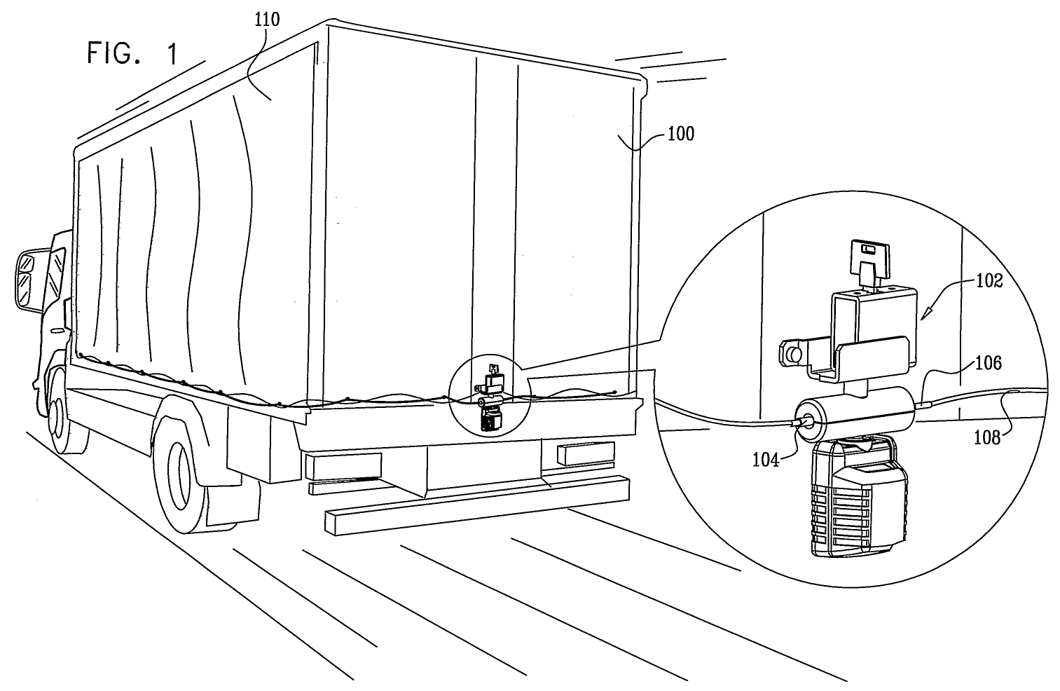

Reference is now made to FIG. 1, which is a simplified pictorial illustration of a truck 100 equipped with a monitorable locking system 102 constructed and operative in accordance with a preferred embodiment of the present invention. Locking system 102 is operative to lock ends 104 and 106 of a cable 108, which is typically threaded through one or more tarpaulins 110 which cover all or part of a cargo space of truck 100, and thus, when locked, prevents unauthorized access to the cargo space.

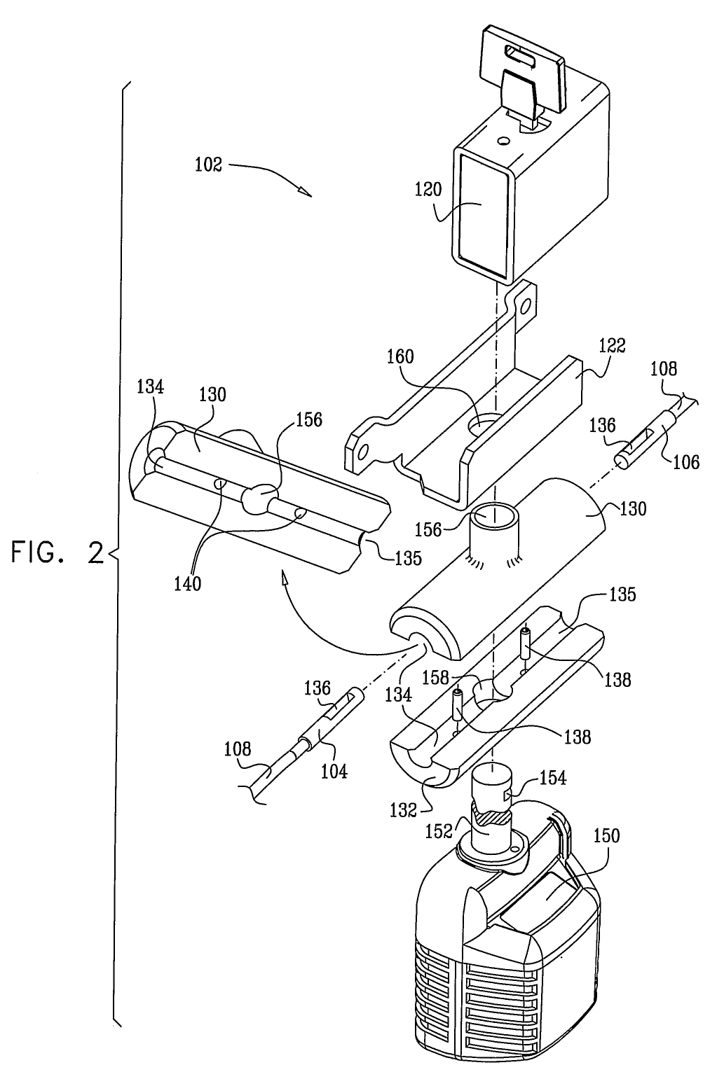

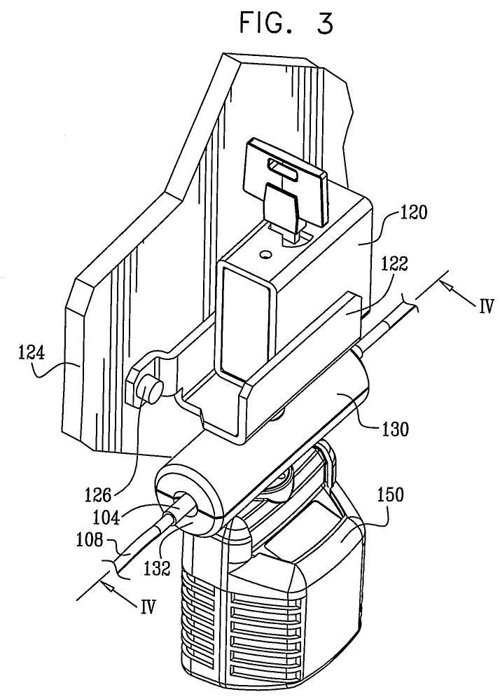

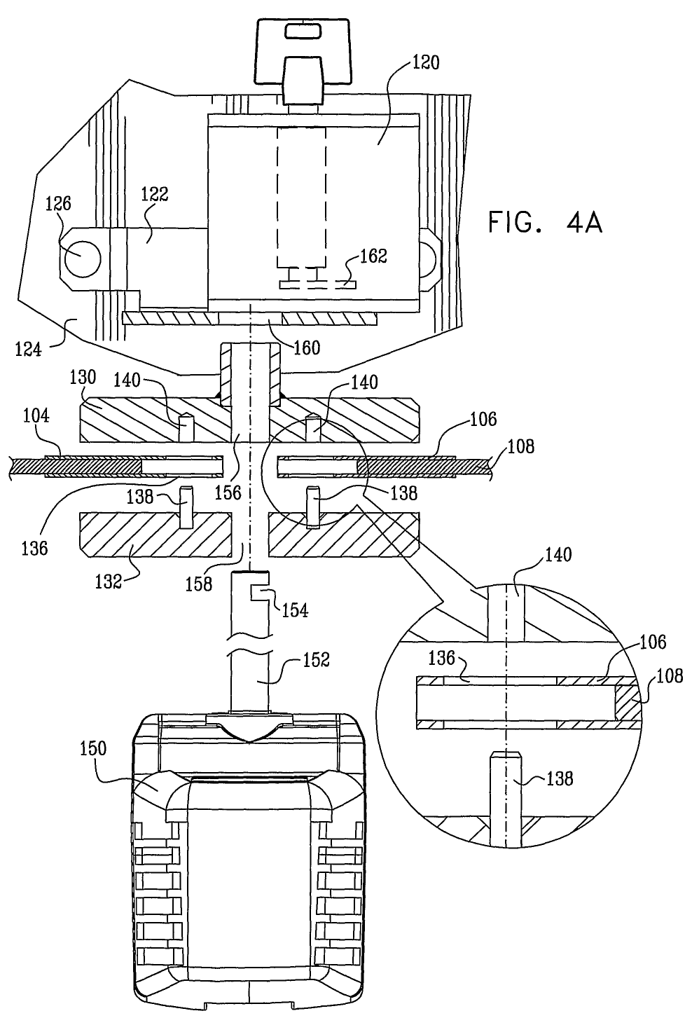

Reference is now made to FIG. 2, which is a simplified exploded view of locking system 102, constructed and operative in accordance with a preferred embodiment of the present invention, and to FIG. 3, which is a simplified assembled view of the locking system 102 of FIGS. 1 & 2 mounted on truck 100.

As seen in FIGS. 2 and 3, locking system 102 typically comprises a conventional pin lock 120, which is commercially available from Mul-T-Lock Ltd. of Yavne, Israel. Pin lock 120 is seated in a mounting bracket 122, which is fixedly mounted onto the chassis 124 of truck 100, as by rivets 126.

Top and bottom cable locking engagement elements 130 and 132 together define longitudinal channels 134 and 135 for receiving respective ends 104 and 106 of cable 108, each of ends 104 and 106 being formed with a throughgoing aperture 136 for receiving a throughgoing transverse locking pin 138. Locking pins 138 are typically seated in bottom cable locking engagement element 132 and extend into corresponding recesses 140 in upper cable locking engagement element 130, when engagement elements 130 and 132 are brought together for locking.

A monitorable locking element assembly 150, preferably one of the model IG-LK-40 series, commercially available from Hi-G-Tek Ltd., of Yavne, Israel, having a pin 152 formed with a transverse slot 154 formed at its end, is configured to extend through respective pin apertures 156 and 158 in top and bottom cable locking engagement elements 130 and 132, and through an aperture 160 in mounting bracket 122 into lockable engagement with pin lock 120. Monitorable locking element assembly 150 is operative such that unlocking of pin lock 120 from pin 152 or unauthorized disengagement of bottom cable locking engagement element 132 from upper cable locking engagement element 130, such as in an unauthorized attempt to disengage cable ends 104 and 106 from the locking system or otherwise tamper with the locking system, will be monitored and wirelessly notified to a monitoring center (not shown).

According to an alternative embodiment of the present invention, cable 108 may itself be a monitorable cable such that an attempt to cut or otherwise tamper with the cable is monitored and also wirelessly notified to a monitoring center, via monitorable lock assembly 150 or via another monitoring transducer.

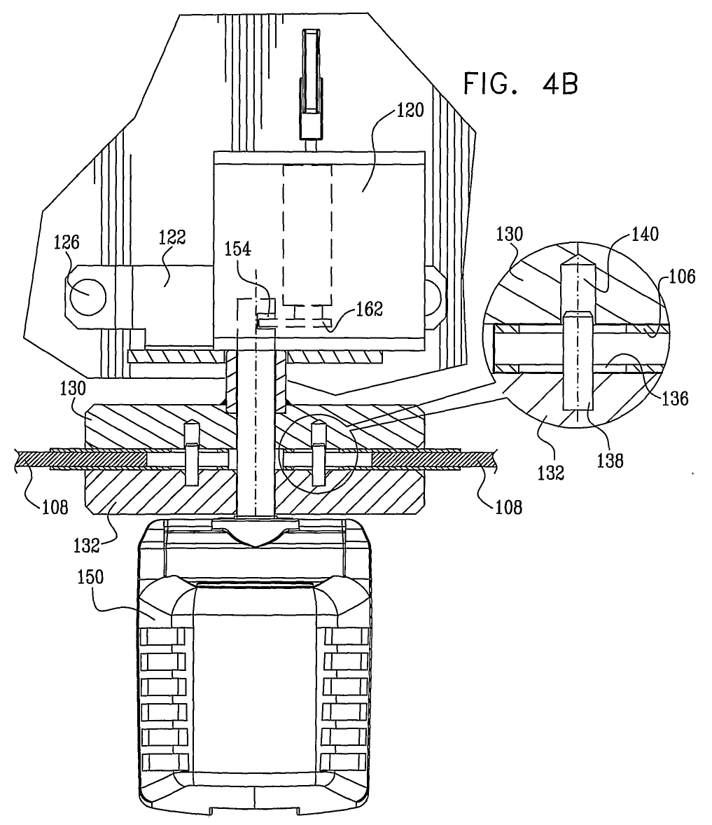

FIGS. 4A & 4B illustrate locking system 102 and its constituent elements prior to locking and following locking. FIG. 4B shows a locking element 162 of pin lock 120 in locking engagement with transverse slot 154 of pin 152 of monitorable locking element assembly 150. As seen in FIG. 4B, top cable locking engagement element 130 engages aperture 160 in mounting bracket 122 so that top and bottom cable locking engagement elements 130 and 132 together provide a protective covering for pin 152 of monitorable locking element assembly 150.

It is appreciated that the use of locking system 102 is not limited to a truck and that locking system 102 may be used with any covering including a cable, such as, but not limited to, a container covering, a palette covering, or any other cargo covering.

It will be appreciated by persons skilled in the art that the present invention is not limited to what has been particularly shown and described hereinabove. Rather the invention includes both combinations and subcombinations of features described hereinabove as well as variations thereof which would be apparent to those reading the aforesaid description and are not in the prior art.

1. A monitorable locking system for a truck cargo compartment closing cable including:
a cable engagement assembly arranged to selectably retain cable ends in mutually locked engagement;
a monitorable locking element assembly; and
a mechanical lock for locking engagement with said monitorable locking element assembly via said cable engagement assembly, thus locking said cable ends in mutually locked engagement.

2. A monitorable locking system according to claim 1 and wherein said monitorable locking element assembly communicates wirelessly with a monitoring center.

3. A monitorable locking system according to claim 2 and wherein said cable comprises a monitorable cable communicating wirelessly with a monitoring center.

4. A monitorable locking system according to claim 1 and wherein said cable comprises a monitorable cable communicating wirelessly with a monitoring center.

5. A monitorable locking system for a cargo covering closing cable including:
a cable engagement assembly arranged to selectably retain cable ends in mutually locked engagement;
a monitorable locking element assembly; and
a mechanical lock for locking engagement with said monitorable locking element assembly via said cable engagement assembly, thus locking said cable ends in mutually locked engagement.

6. A monitorable locking system according to claim 5 and wherein said monitorable locking element assembly communicates wirelessly with a monitoring center.

7. A monitorable locking system according to claim 6 and wherein said cable comprises a monitorable cable communicating wirelessly with a monitoring center.

8. A monitorable locking system according to claim 5 and wherein said cable comprises a monitorable cable communicating wirelessly with a monitoring center.
